(19) United States
(12) Patent Application Publication
(10) Pub. No.: US 2014/0067635 A1
(43) Pub. Date: Mar. 6, 2014

(54) Quote Convention for Spreads Between Products Having Non-Homogeneous Construction

(71) Applicants: Peter Barker, Chicago, IL (US); Suzanne Spain, Chicago, IL (US); James Wilcox, Wheaton, IL (US); Michael Kamradt, Flossmoor, IL (US); John Labuszewski, Westmont, IL (US)

(72) Inventors: Peter Barker, Chicago, IL (US); Suzanne Spain, Chicago, IL (US); James Wilcox, Wheaton, IL (US); Michael Kamradt, Flossmoor, IL (US); John Labuszewski, Westmont, IL (US)

(21) Appl. No.: 13/605,562

(22) Filed: Sep. 6, 2012

(51) Int. Cl. G06Q 40/06

(52) U.S. Cl. 705/35

(57) ABSTRACT

The disclosed embodiments relate to systems and methods for determining a quotation price of a spread between multiple products, such as two or more futures contracts, having non-homogeneous construction, e.g. one may be specified in terms of an implied rate, such as a Eurodollar Futures contract, and the other may be specified in terms of a price, such a U.S. Treasury Futures contract. The disclosed embodiments normalize the valuation of each “leg” of the spread with respect to each other, accounting for the divergence of the underlying contract construction, so that a difference in those valuations may be computed.

### BACKGROUND

A financial instrument trading system, such as a futures exchange, referred to herein also as an “Exchange”, such as the Chicago Mercantile Exchange Inc. (CME), provides a contract market where financial products/instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time, referred to as the expiration date or expiration month. An option is the right, but not the obligation, to sell or buy the underlying instrument (in this case, a futures contract) at a specified price within a specified time. The commodity to be delivered in fulfillment of the contract, or alternatively, the commodity, or other instrument/asset, for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract price.

Typically, the Exchange provides for a centralized “clearing house” through which all trades made must be confirmed, matched, and settled each day until offset or delivered. The clearing house is an adjunct to the Exchange, and may be an operating division thereof, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

Current financial instrument trading systems allow traders to submit orders and receive confirmations, market data, and other information electronically via a network. These “electronic” marketplaces have largely supplanted the pit based trading systems whereby the traders, or their representatives, all physically stand in a designated location, i.e. a trading pit, and trade with each other via oral and hand based communication. In contrast to the pit based trading system where like-minded buyers and sellers can readily find each other to trade, electronic marketplaces must electronically “match” the orders placed by buyers and sellers on behalf thereof. Electronic trading systems may offer a more efficient and transparent system of trading. For example, in pit trading, subjective elements and limits on human interaction may unduly influence the process by which buyers and sellers come together to trade or otherwise limit the trading opportunities, limiting market liquidity. In contrast, an electronic exchange may be more objective when matching up a buyer and seller, relying solely on objective factors such as price and time of order placement, etc. As such, electronic trading systems may achieve more fair and equitable matching among traders as well as identify more opportunities to trade, thereby improving market liquidity.

Spread trading involves the simultaneous purchase and sale of multiple futures contracts, options, etc., referred to as “legs,” in order to profit from the price difference and/or hedge against the risk there between. Types of spreads include calendar spreads and inter-commodity spreads. One exemplary spread is the Treasury/Eurodollar (or “TED”) spread.

TED spreads have been traded since the early 1980's concurrent with the introduction of Eurodollar futures. These spreads had originally been constructed using CME 90-day Treasury bill futures vs. CME 90-day Eurodollar futures contracts. Both of those contracts are quoted using the so-called International Monetary Market (“IMM”) Index or (100—Yield).

Because of the common quote convention and other similarities with respect to Eurodollar and T-bill futures contract construction, e.g., $1 million nominal contract size, 90-day term, the spread could be quoted directly as the value of the T-bill futures contract less the value of the Eurodollar futures contract. That is, Eurodollar futures are based on a nominal $1 million face value, 90-day Eurodollar time deposit. They are settled in cash at the 3-month Eurodollar Time Deposit Rate calculated daily by the British Bankers Association (BBA) through a survey process. The contract settles on the 2nd business day prior to the 3rd Wednesday of the contract month (“IMM dates”). Contracts are available in the March quarterly cycle of March, June, September and December extending 10 years into the future. The 1st four “serial” or non-March quarterly cycle months are also available for trade. The contract is quoted per the “IMM Index” or 100 less the yield. Thus, a yield of 0.855% is quoted at 99.145 (=100.00−0.855).

Since the 1980s, however, the T-bill contract has fallen into disuse. However, the market remains very interested in trading the spread between private credit risks implied in Eurodollar yields and public credit risks implied in Treasury yields.

### BRIEF DESCRIPTION OF THE DRAWINGS

FIG. 1 depicts an illustrative computer network system that may be used to implement aspects of the disclosed embodiments.

FIG. 2 a block diagram of an exemplary implementation of the system for use with the system of FIG. 1 for determining a quotation price according to one embodiment.

FIG. 3 depicts a flow chart showing operation of the system of FIGS. 1 and 2.

FIG. 4 shows an illustrative embodiment of a general computer system for use with the system of FIGS. 1 and 2.

FIG. 5 depicts an exemplary graph of swap rates over treasury spreads.

### DETAILED DESCRIPTION

The disclosed embodiments relate to systems and methods for determining a quotation price of a spread between multiple products, such as two or more futures contracts, having non-homogeneous construction, e.g. one may be specified in terms of an implied rate, such as a Eurodollar Futures contract, and the other may be specified in terms of a price, such as a U.S. Treasury Futures contract. The disclosed embodiments normalize the valuation of each “leg” of the spread with respect to each other, accounting for the divergence of the underlying contract construction, so that a difference in those valuations may be computed.

While the disclosed embodiments may be discussed in relation to futures and/or options on futures trading, it will be appreciated that they may be applicable to any equity, options or futures trading system, e.g., exchange, Electronic Communication Network (“ECN”), Alternative Trading System (“ATS”), or Swap Execution Facility (“SEF”), or market now available or later developed, e.g. cash, Futures, etc., as well as any instrument traded thereon. It will be appreciated that a trading environment, such as a futures exchange as described herein, implements one or more economic markets where rights and obligations may be traded.

While the disclosed embodiments, will be discussed in relation to US Treasury/Eurodollar spreads, and in particular, US Treasury/Eurodollar Futures pack spreads, it will be appreciated, as will be described, that the disclosed embodiments may be applicable to other spreads, now available or later developed, between products/contracts having similar divergent constructions and valuations.

As was discussed above, traders may construct TED spreads using Treasury futures contracts and combinations of Eurodollar futures contracts. However, Treasury futures contracts are constructed and quoted very differently than Eurodollar futures. E.g., they are quoted in terms of a price expressed in percent of par, they are generally based upon a $100,000 face value delivery unit and call for the delivery of Treasuries with original terms of 2-, 3-, 5-, 10- and 30-years. That is, treasury note and bond futures contracts are available based on 2-, 3-, 5-, 10- and 30-year Treasury securities. They generally call for the delivery of $100,000 face value of Treasury securities with the exception of the 2-year and 3-year T-note contracts that call for the delivery of $200,000 face value of securities. These contracts are quoted in percent of par in minimum increments of 1/32nd of 1% of par or sometimes in finer increments of ½ of 1/32nd. They permit the delivery of a variety of Treasury securities within a specified maturity window, at the discretion of the short. E.g., the 10-year T-note futures contract permits the delivery of T-notes with a remaining maturity between 6½ to 10 years. This includes a rather wide variety of securities with varying coupons and terms until maturity. Because these securities may be valued at various levels, the contract utilized a Conversion Factor (CF) invoicing system to determine the price paid by long to compensate the short for the delivery of the specific security. Specifically, the principal invoice amount paid from long to short upon delivery of securities is calculated as a function of the futures price multiplied by the CF. Technically, CFs are calculated as the price of the particular security as if they were yielding the “futures contract standard” of 6%. The system is intended to render equally economic the delivery of any eligible for delivery security. However, the mathematics of the CF system is such that a single security tends to stand out as most economic or cheapest-to-deliver (CTD) in light of the relationship between the invoice price of the security vs. the current market price of the security. Typically, long duration securities are CTD when prevailing yields are in excess of the 6% futures market standard; while short duration securities are CTD when prevailing yields are less than 6%. It is important to identify the CTD security because futures will tend to price or track or correlate most closely with the CTD.

Because Treasury futures and Eurodollar futures are constructed so differently, it is difficult to compare the value of the two contracts.

In one embodiment, a methodology for quoting and trading TED spreads constructed using a combination of Treasury and Eurodollar futures is provided.

Generally, the TED spread represents a measure of marketplace perception of the credit risks implied by a private investment (in the form of a Eurodollar investment) vs. the public credit risks implied by a Treasury security. The popularity of the TED spread was enhanced by various credit events affecting the marketplace over the years. All these events and others have created “pops” in the yield spread between private and public debt instruments. Notable events include the Continental Illinois Bank crisis of 1984, the savings and loan failures and subsequent bailout of the early 1990's, the Russian and subsequently Asian financial crisis in 1997-1999, the U.S. Treasury's comments questioning their level of financial support for the housing agencies (i.e., Freddie, Fannie) in 2000, the bursting of the “dot-com” bubble in 2001, the subprime mortgage crisis beginning in 2007 and the European sovereign debt crisis of the 2010's.

While CME Group's T-bill futures contract has fallen into disuse, the popularity of Eurodollar futures has transcended all other short-term interest rate contracts. Nonetheless, the TED spread lives on as a popular device for trading credit risks.

Because cash or spot Eurodollar investments do not extend beyond one-year in term, it is difficult to compare longer-term Treasury yields to Eurodollar yields. Rates associated with term interest rate swaps (IRS) instruments are sometimes referenced as a proxy for longer-term Eurodollar yields.

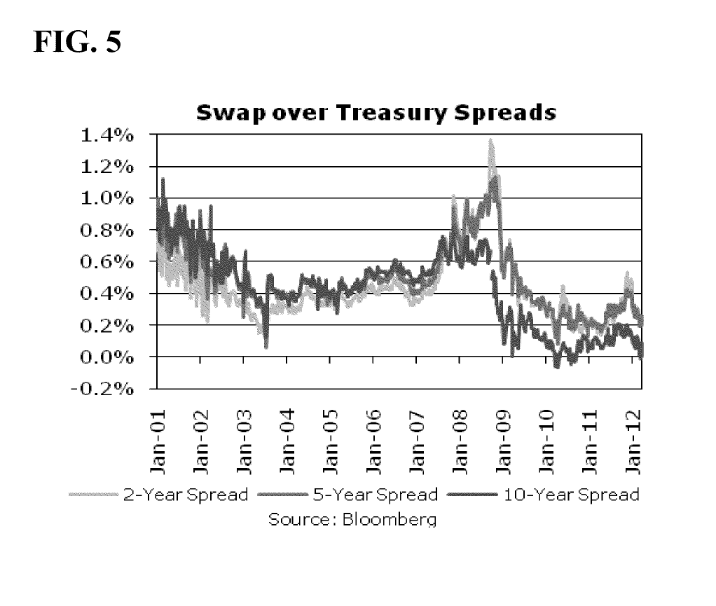

This is reasonable given the close relationship, as shown in FIG. 5 between IRS's and Eurodollar futures as a pricing mechanism and hedging tool. Thus, the “swap spread” or spread of swap rates over Treasury rates is sometimes utilized as a proxy for TED spreads.

TED spreads may be constructed with the use of Eurodollar futures vs. cash Treasury notes. Or, one may facilitate the trade with use of 2-year, 5-year, 10-year Treasury note futures vs. Eurodollar futures.

Considering a term TED spread including Eurodollar and T-note futures as components, not all yields are created equal. Yields associated with money market instruments, such as Eurodollars, are calculated using different assumptions than the yield quoted on a coupon bearing instrument, such as Treasury notes. Fixed income traders need be careful to assure that they are comparing similar parameters.

Yields associated with Eurodollar or LIBOR quotes are known as money market yields (MMY). Note that Eurodollars are so-called “add-on” instruments where one invests the stated face value and receives the original investment plus interest at term.

Thus, one's interest may be calculated as a simple function of the face value (FV), rate (R) and days to maturity (d).

$$Interest = FV [ R \times ( \frac{d}{360} ) ]$$

E.g., if one were to purchase a $1 million face value unit of 90-day Euros with MMY=0.75%, one would receive the original $1 million face value (FV) investment plus interest of $1,875 at the conclusion of the 90 days.

$$\begin{matrix}Interest = \$1 , 000 , 000 \times [ 0.75 \% \times ( \frac{90}{360} ) ] \\ = \$1 , 875\end{matrix}$$

MMYs suffer from the mistaken assumption that there are but 360 days in a year (a “money-market” year). As such, MMYs are not completely comparable to the bond equivalent yield (BEY) quoted on Treasury notes that imply semi-annual coupon payments. The following adjustment may be made to render the two quotes comparable.

$$BEY = MMY \times ( \frac{365}{360} )$$

E.g., assume you have a 90-day money market instrument yielding 0.75%. Let's convert that figure to a bond-equivalent yield. Note that the BEY of 0.76% slightly exceeds the MMY.

$$\begin{matrix}BEY = 0.75 \% \times ( \frac{365}{360} ) \\ = 0.76 \%\end{matrix}$$

Complicating the calculation is the fact that notes and bonds offer semi-annual coupon payments. Thus, money market instruments that require the investor to wait until maturity for any return do not contemplate interim compounding.

Thus, the formula provided above is only valid for instruments with less than 6-months (183-days) to term. If there are 183 or more days until term, use the following formula where P=price or original investment and i=interest.

$$BEY = \frac{( \frac{- d}{365} ) + \sqrt{{( \frac{d}{365} )}^{2} - [ ( \frac{2 d}{365} ) - 1 ] [ 1 - ( \frac{P + i}{P} ) ]}}{( \frac{d}{365} ) - 0.5}$$

E.g., Consider a 270-day Euro investment quoted at a MMY=0.90%. Using the formula above, this investment will produce interest of i=$6,750 over its 270 day life. The Bond Equivalent Yield may be calculated as 0.91%.

$$\begin{matrix}BEY = \frac{( \frac{- 270}{365} ) + \sqrt{\begin{matrix}{( \frac{270}{365} )}^{2} - [ ( \frac{2 \times 270}{365} ) - 1 ] \\ [ 1 - ( \frac{ \$1 , 000 , 000 + \$6 , 750}{\$1 , 000 , 000} ) ]\end{matrix}}}{( \frac{270}{365} ) - 0.5} \\ = 0.91 \%\end{matrix}$$

The result is that it is not necessarily an easy or straightforward task to compare the yields associated with a Treasury security to the yield associated with Eurodollars. But this is hardly the only complication that a prospective TED trader faces.

Further complications associated with the construction of a TED spread using Eurodollar and Treasury futures are implied by divergent contract construction terms. Eurodollar futures are based upon a 90-day $1,000,000 face value instrument. Treasury futures may be of very different terms ranging up to 30-years, generally based upon a $100,000 face value unit with the notable exception of the 2-year and 3-year T-note futures contracts based upon a $200,000 face value unit.

How best to address these circumstances when constructing a TED spread? One popular method is to trade a strip of Eurodollar futures, i.e., a series of futures in successively deferred delivery months as a proxy for a term investment vs. an appropriately weighted quantity of Treasury note futures with a comparable term. However, the construction of a Eurodollar strip, possibly in the form of Eurodollar bundle, may be a bit cumbersome. Accordingly, another method may utilize a Eurodollar pack.

Because strips are frequently traded, the Exchange has created ways to trade them conveniently in the form of “packs” and “bundles.” A bundle represents a series of successive quarterly Eurodollar futures. E.g., one may buy (sell) a 2-year bundle by buying (selling) the first 8 quarterly Eurodollar futures. A 5-year bundle represents the first 20 quarterly Eurodollar futures. A “pack” represents a series of 4 successively deferred Eurodollar futures in a single “contract year.” E.g., it is March 2012, one may buy (sell) a pack by buying (selling) March 13, June 13, September 13 and December 13 futures. Buy (sell) a fifth-year pack by buying (selling) March 16, June 16, September 16 and December 16 futures. Packs and bundles are quoted as a single value representing the average net change in all Eurodollar futures included in the package, e.g., +4 basis points, −7.5 basis points. Once transacted, prices are assigned to the individual legs of the pack or bundle.

A Eurodollar futures pack represents an aggregation of four quarterly expiration Eurodollar futures in consecutive months traded simultaneously. For example, one may buy a pack by buying the June 2013, September 2013, December 2013 and March 2014 Eurodollar futures contracts, constituting a pack. Or, sell a pack by selling the June 2014, September 2014, December 2014 and March 2015 Eurodollar futures contracts, constituting yet another pack.

Packs are often referred to by color designations. The “white pack” refers to the first four quarterly expiration Eurodollar futures; the “red pack” is the subsequent four futures; the “green pack” is the next four futures, . . . , a “gold pack” represents four quarterly Eurodollar futures going out five years on the curve.

Just as it may be cumbersome to utilize a strip of Eurodollar futures in the context of a TED spread, it may likewise be cumbersome to utilize cash Treasury securities. But Treasury note futures are available and may conveniently be spread against a Eurodollar pack. That is, one wishing to buy or go long the TED Spread may buy T-Note Futures and sell a Eurodollar Pack and one wishing to sell or go short the TED Spread may sell T-Note Futures and buy a Eurodollar Pack. One might buy the credit spread (buy T-Note futures/sell Eurodollar futures) in anticipation of a widening TED spread. Or, one may sell the TED spread (sell T-Note futures/buy Eurodollar futures) in anticipation of a narrowing credit spread.

In order to assure that the TED spread described above will really reflect the relative credit risks implied by the private vs. public debt sectors, it will become necessary to weight the spread. Thus, the risk exposure associated with the two instruments must be matched given an assumption that the yields on pair move in a parallel manner (that is, the prices/yields on each leg, i.e. each contract, of the spread move in a parallel manner), i.e., balance the risk associated with T-Note futures with an appropriately offsetting number of Eurodollar packs . . . to balance any change (Δ) in the value of the T-note futures with an opposite change in the value of the Eurodollar pack, given an equivalent shift in yields.

ΔValue of T−Note Futures˜ΔValue of Eurodollar Pack

But what can't be measured, i.e. the TED spread due to the different quote conventions, can't be managed. Basis point value (BPV) measures the monetary change in the value of an instrument in response to a one basis point (0.01%) change in yield as follows. BPVs may be utilized as a proxy for the more abstract concept of change.

The BPV for a money market instrument such as those represented by Eurodollar futures may be calculated as follows, where FV=face value of instrument and d=days to maturity.

$${BPV}_{ED} = FV \times ( \frac{d}{360} ) \times 0.01 \%$$

E.g., find the basis point value (BPV) of a $1 million face value 90-day exposure as represented by one Eurodollar futures contract. By plugging these values into our equation as shown above, we may calculate the basis point value associated with one $1 million face value 90-day Eurodollar futures contract (BPV_{ED}) as $25.00 (BPV_{ED}=$25.00).

$$\begin{matrix}{BPV}_{ED} = \$1 , 000 , 000 \times ( \frac{90}{360} ) \times 0.01 \% \\ = \$25 .00\end{matrix}$$

The BPV associated with a money market instrument such as a LIBOR investment may be found by a simple linear function to the face value (FV) and the term in days (d) of the instrument. Thus, the basis point value of a pack of four Eurodollar futures (BPV_{pack}) is simply $100 (=4×$25).

Likewise, the BPV associated with a T-Note futures contract must be found. However, the calculations are a bit more complex. Note that 2-year T-note futures permit the delivery of $200,000 face value of U.S. Treasury notes with an original maturity no greater than 5 years, 3 months and a remaining term until maturity between 1 years, 9 months and 2 years, regardless of coupon. At any given time, there will be a number of T-notes which will eligible for delivery or deliverable. Further note that T-note futures are quoted in 32nds or fractions of a 32nd. One thirty-second of the $200,000 face value unit deliverable against a 2-year T-note futures contract equals $62.50. Quotation devices may show a quote of 106 percent of par plus 16 thirty-seconds as 106-16. If you add 1/64th, the quote may appear as 106-16+ or as 106-165. Add a 1/128th and the quote may appear as 106-162 . . . add 3/128ths and the quote may appear as 106-167. In the two latter cases, the trailing “5” is typically truncated.

The conversion factor (CF) invoicing system, described above, is (theoretically) designed to render equally economic the delivery of any eligible for delivery T-note. In practice, however, a single security stands out as most economic or cheapest to deliver (CTD) in light of the difference between cash values and the invoice price a buyer would pay to seller upon delivery calculated as a function of the futures price multiplied by the conversion factor plus any accrued interest.

Invoice Price=(Futures Settlement×CF)+Accrued Interest

Thus, it is necessary to identify the CTD security and its basis point value (BPV_{ctd}). The effective basis point value of a T-note futures contract (BPVₜ₋ₙₒₜₑ) is equal to the basis point value of the CTD security divided by the conversion factor.

BPV_{T-note}=BPV_{ctd}÷CF_{ctd}

E.g., on Apr. 25, 2012, the cheapest to deliver 2-year T-note was the 1¾% of March 2014. It had a BPV of $39.20 per $200,000 face value and a conversion factor for delivery into the June 2012 2-year futures contract of 0.9303. Thus, the effective BPV of the futures contract may be calculated as $37.04.

BPV_{T-note}=$39.20÷0.9303=$42.14

Armed with the information above, the appropriate “Contract Quantity Ratio” (CQR) may be identified which would balance a TED spread constructed using Eurodollar packs vs. 2-year T-note futures. The HR that indicates the appropriate number of T-note futures to trade vs. Eurodollar packs may be calculated as follows.

CQR=BPV_{pack}÷BPV_{T-note}

E.g., how many June 2012 2-year T-note futures must be traded to balance a single Eurodollar pack? We had calculated a BPVpack=$100.00 and a BPVtnote=$42.14. Plugging this information into our formula, we calculate a CQR=2.37 or roughly five (5) 2-year T-note futures for every two (2) packs.

CQR=$100.00÷$42.14=2.37 or five (5) Note futures vs. 2 Eurocdollar futures packs

In other words, one might trade the above described TED spread in a ratio of 5:2. Note that it is easy to reference the appropriate CQR with commercial quotation devices such as the Bloomberg system.

While this analysis helps us define how to construct a balanced spread, it does not address the question of how the spread may be quoted.

Accordingly, in order to determine the quotation price of a TED spread, such as a TED spread using Treasury futures vs. Eurodollar packs, the following terms are defined: “Spread Tick”, “Leveling Ratio”, and “Spread Ratio”.

“Spread Tick”—the spread tick is defined as the minimum price increment or tick associated with the Treasury futures contract of choice, expressed in dollars, multiplied by the number of Treasury contracts required per the Contract Quantity Ratio (CQR) calculation as described above.

Spread Tick=Treasury Tick in $×# Treasury Contracts

E.g., per the calculation of the CQR as above, one might spread five (5) 2-year T-note futures vs. two (2) Eurodollar futures packs. The “tick” size is 1/32nd of 1% of $200,000 face value or par. This equates to $62.50 (= 1/32nd of 1% of $200,000).

The number of 2-year T-note contracts required per the 5:2 CQR is five (5). Thus, the spread tick may be calculated as $78.15 per spread.

Spread Tick=$62.50×5=$312.50

While the tick is regarded as 1/32nd, the minimum price increment in 2-year T-note futures is one quarter of 1/32nd of 1% of par or $15.625 [=¼th of 1/32nd of 1% of $200,000], known as a “quarter tick.”

“Leveling Ratio”—The leveling ratio (or “LR”) is defined as the difference, expressed in dollars, in base tick values that must be “leveled” to balance the two values. This leveling ratio is reflected in the ratio between the Treasury tick and the value of the tick associated with a Eurodollar futures pack.

Leveling Ratio=Treasury Tick÷Eurodollar Pack Tick

E.g., per our example referencing 2-year T-note futures with a tick value of $62.50 and Eurodollar futures pack with a tick value of $100.00 (=4 contracts×$25.00 per tick), the leveling ratio may be expressed as 0.625

Leveling Ratio=$62.50÷$100.00=0.625

The Eurodollar futures “tick” is regarded as one basis point (0.01%) or $25.00. Thus, the tick associated with a pack of four (4) Eurodollar futures equals $100.00. Note, however, that Eurodollar futures may be traded in minimum increments of ½ of one basis point ($12.50) and even in increments of ¼th of one basis point ($6.25) in the nearest expiring contract month. These alternate increments are known as a “half tick” or “quarter tick,” respectively.

“Spread Ratio”—the “spread ratio” (or “SR”) may be defined by reference to the number of contracts in the spread, as indicated in the Contract Quantity Ratio or CQR as explained above, further adjusted by the Leveling Ratio.

$$Spread Ratio = Leveling Ratio \times ( \frac{No . Treasury Futures}{No . Eurodollar Packs} )$$

E.g., as indicated above, the spread may be constructed using five (5) 2-year T-note futures vs. two (2) red Eurodollar futures packs. The leveling ratio was calculated as 0.625. Thus, the spread ratio equals 1.5625

Spread Ratio=0.625×(5/2)=1.5625

Quoting the Spread—The disclosed quote convention is based on the change in the value of Treasury futures (ΔTreasury) from the previous day's closing or settlement price, compared to the change in the value of Eurodollar futures pack (ΔPack) from the previous day's closing or settlement price.

This quote methodology is analogous with the manner in which Eurodollar futures packs and bundles are currently quoted. Packs and bundles are quoted as a single value representing the average change in all Eurodollar futures included in the package, e.g., +4 basis points, −7.5 basis points. Once transacted, prices are assigned to the individual legs of the pack or bundle.

These changes would be compared on a proportionate basis by reference to the Spread Ratio (SR) as defined above.

$$Quote = Δ Treasury - ( \frac{Δ Pack}{Spread Ratio} )$$

E.g., assume that the 2-year Treasury futures contract is quoted as down 3½ ticks since the previous day's close while the Eurodollar futures pack extending out 2 years in the future (the “red pack”) is quoted as down 1¼ ticks. The Quote is equal to −2.7 ticks.

$$\begin{matrix}Quote = - 3.5 - ( \frac{- 1.25}{1.5625} ) \\ = - 2.7\end{matrix}$$

This Quote of −2.7 ticks is effectively a quote denominated in 32nds or the tick associated with the Treasury leg of the spread. This quote may be rounded to the nearest minimum price increment. In the case of 2-year T-note futures, the minimum increment equals ¼th of 1/32nd of 1% of par. Because the spread transaction entails the purchase of one leg associated with the offsetting sale of the other leg, one may reference the bids and offers in Treasury futures to find the effective bid and offer in the spread.

If one were to buy (sell) the spread by buying (selling) Treasury futures and selling (buying) Eurodollar packs, that implies that one might buy (sell) Treasury futures at the offer (bid) and sell (buy) Eurodollar packs at the bid (offer). Thus, the electronic trading platform on which the spread is listed may display the effective offer (bid) price of the spread by matching up the Treasury offer (bid) and Eurodollar pack bid (offer) prices.

Leg Price Assignments—Subsequent to an execution of the spread, or the concluded spread transaction, the trade may be booked in electronic bookkeeping systems as separate and distinct positions in Treasury futures and Eurodollar packs. As such, the electronic system must assign specific prices at which the two legs of the spread are booked.

The Eurodollar pack may be booked or priced at the previous day's closing or settlement values. The Treasury leg may be priced at the previous day's closing or settlement value adjusted by the transacted spread value.

TED spread trading may be integrated on an electronic trading platform, such as the CME Group's proprietary CME Globex® matching engine.

In particular, these spreads may be executed using CME Group's “implied spread functionality.” Implied spreads are currently supported in the context of Eurodollar calendar spreads. This means that one may enter a spread order and it may be filled relying upon the liquidity in the two separate contract months that comprise the spread. Or, an outright order may be matched with one leg of a spread order. Similarly, these TED spreads may be executed against outright orders in the Treasury and Eurodollar pack legs of the spread.

In the context of Globex, it is envisioned that these TED spread orders may be accorded precedence over so called “implied spread” or Eurodollar calendar spread orders at any given price. Further, “Good Till Canceled” (GTC) and “Good Till Date” (GTD) orders would not be supported. As such, a resting spread limit order would be considered cancelled at the conclusion of the trade session in which it was entered.

The disclosed TED spread quote methodology is intended to facilitate an active, liquid market in a credit spread that has attracted much interest and activity over the years. Unfortunately, the complexity associated with pricing and executing the spread involving two markets that are divergently constructed has proven problematic. But this invention offers a novel and, hopefully, invigorating solution to these difficulties.

While the above example relates to one form of TED spread, it will be appreciated that the disclosed embodiments may be utilized with any spread between non-homogeneous leg constructions, such as spreads between currency futures and short-term interest rate futures, currency futures and treasury futures, or crude oil futures and natural gas futures where the spread is balanced on a ratio driven by BTU values.

As was discussed above, an exchange provides one or more markets for the purchase and sale of various types of products including financial instruments such as stocks, bonds, futures contracts, options, currency, cash, and other similar instruments. Agricultural products and commodities are also examples of products traded on such exchanges. A futures contract is a product that is a contract for the future delivery of another financial instrument such as a quantity of grains, metals, oils, bonds, currency, or cash. Generally, each exchange establishes a specification for each market provided thereby that defines at least the product traded in the market, minimum quantities that must be traded, and minimum changes in price (e.g., tick size). For some types of products (e.g., futures or options), the specification further defines a quantity of the underlying product represented by one unit (or lot) of the product, and delivery and expiration dates. As will be described, the Exchange may further define the matching algorithm, or rules, by which incoming orders will be matched/allocated to resting orders.

Some products on an exchange are traded in an open outcry environment where the exchange provides a location for buyers and sellers to meet and negotiate a price for a quantity of a product. Other products are traded on an electronic trading platform (e.g., an electronic exchange), also referred to herein as a trading platform, trading host or Exchange Computer System, where market participants, e.g. traders, use software to send orders to the trading platform. The order identifies the product, the quantity of the product the trader wishes to trade, a price at which the trader wishes to trade the product, and a direction of the order (i.e., whether the order is a bid, i.e. an offer to buy, or an ask, i.e. an offer to sell).

The Exchange Computer System, as will be described below, monitors incoming orders received thereby and attempts to identify, i.e., match or allocate, as will be described in more detail below, one or more previously received, but not yet matched, orders, i.e. limit orders to buy or sell a given quantity at a given price, referred to as “resting” orders, stored in an order book database, wherein each identified order is contra to the incoming order and has a favorable price relative to the incoming order. An incoming order may be an “aggressor” order, i.e., a market order to sell a given quantity at whatever may be the resting bid order price(s) or a market order to buy a given quantity at whatever may be the resting ask order price(s). In particular, if the incoming order is a bid, i.e. an offer to buy, then the identified order(s) will be an ask, i.e. an offer to sell, at a price that is identical to or higher than the bid price. Similarly, if the incoming order is an ask, i.e. an offer to sell, the identified order(s) will be a bid, i.e. an offer to buy, at a price that is identical to or lower than the offer price.

Upon identification (matching) of a contra order(s), a minimum of the quantities associated with the identified order and the incoming order is matched and that quantity of each of the identified and incoming orders become two halves of a matched trade that is sent to a clearinghouse. The Exchange Computer System considers each identified order in this manner until either all of the identified orders have been considered or all of the quantity associated with the incoming order has been matched, i.e. the order has been filled. If any quantity of the incoming order remains, an entry may be created in the order book database and information regarding the incoming order is recorded therein, i.e. a resting order is placed on the order book for the remaining quantity to await a subsequent incoming order counter thereto.

Traders access the markets on a trading platform using trading software that receives and displays at least a portion of the order book for a market, i.e. at least a portion of the currently resting orders, enables a trader to provide parameters for an order for the product traded in the market, and transmits the order to the Exchange Computer System. The trading software typically includes a graphical user interface to display at least a price and quantity of some of the entries in the order book associated with the market. The number of entries of the order book displayed is generally preconfigured by the trading software, limited by the Exchange Computer System, or customized by the user. Some graphical user interfaces display order books of multiple markets of one or more trading platforms. The trader may be an individual who trades on his/her behalf, a broker trading on behalf of another person or entity, a group, or an entity. Furthermore, the trader may be a system that automatically generates and submits orders.

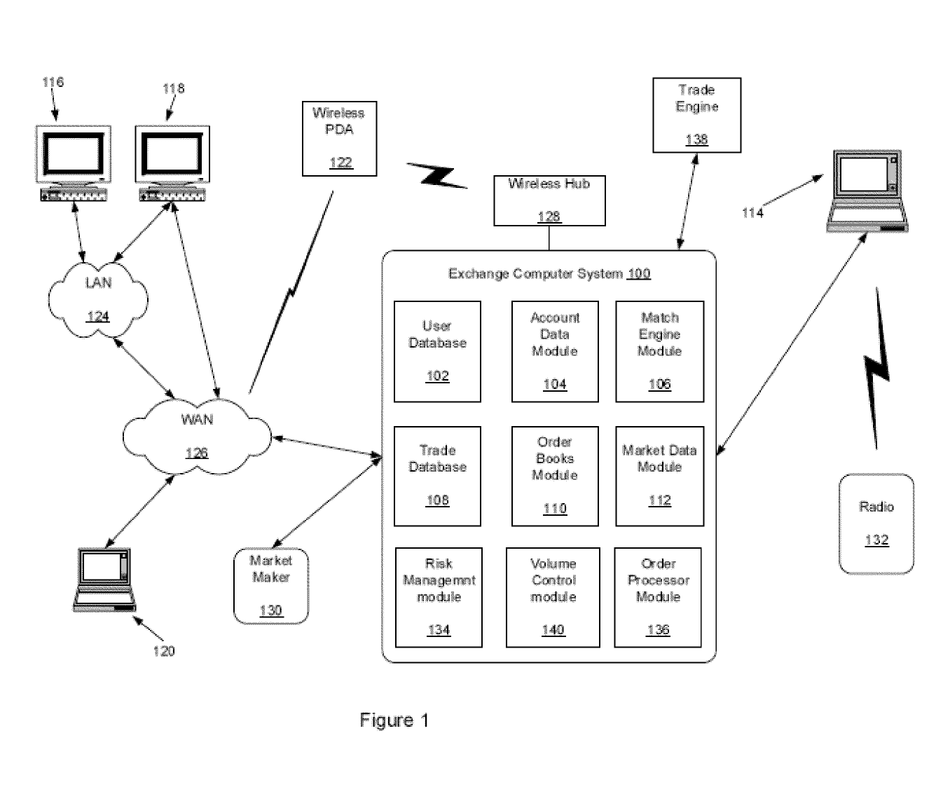

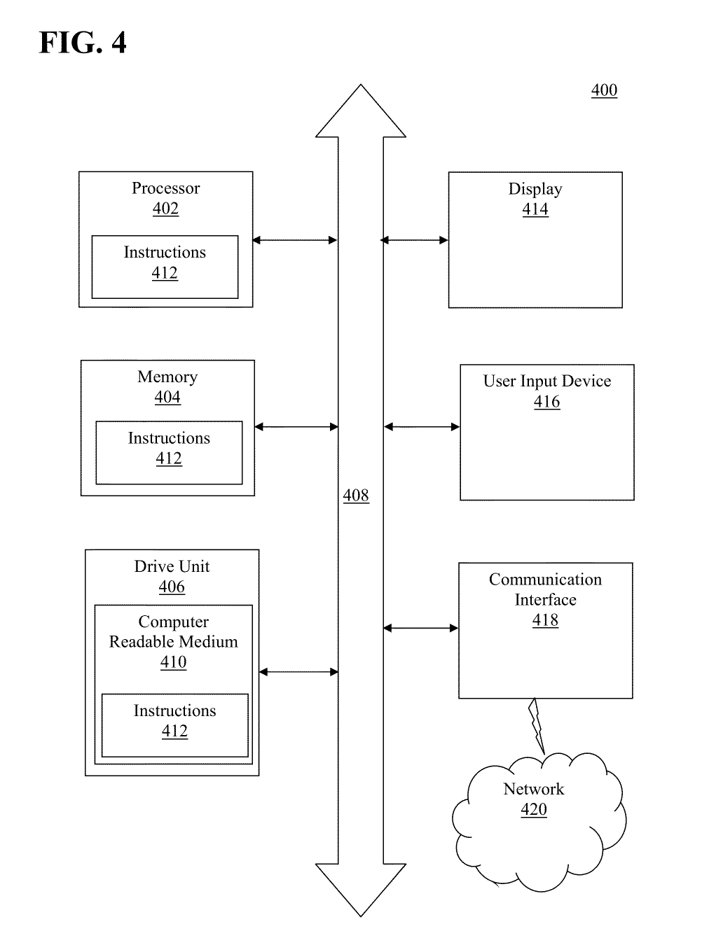

The disclosed embodiments are preferably implemented with computer devices and computer networks, such as those described with respect FIG. 4, that allow users, e.g. market participants or traders, to exchange trading information. It will be appreciated that the plurality of entities utilizing the disclosed embodiments, e.g. the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the exchange. An exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as will be described below, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The exchange computer system 100 may be implemented with one or more mainframe, desktop or other computers, such as the computer 400 described below with respect to FIG. 4. A user database 102 may be provided which includes information identifying traders and other users of exchange computer system 100, such as account numbers or identifiers, user names and passwords. An account data module 104 may be provided which may process account information that may be used during trades. A match engine module 106 may be included to match bid and offer prices and may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by the order book module 110 and/or match engine module 106. A volume control module 140 may be included to, among other things, control the rate of acceptance of mass quote messages in accordance with one or more aspects of the disclosed embodiments. It will be appreciated that concurrent processing limits may be defined by or imposed separately or in combination, as was described above, on one or more of the trading system components, including the user database 102, the account data module 104, the match engine module 106, the trade database 108, the order book module 110, the market data module 112, the risk management module 134, the order processing module 136, or other component of the exchange computer system 100.

The trading network environment shown in FIG. 1 includes exemplary computer devices 114, 116, 118, 120 and 122 which depict different exemplary methods or media by which a computer device may be coupled with the exchange computer system 100 or by which a user may communicate, e.g. send and receive, trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may comprise a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based computer device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

As was described above, the users of the exchange computer system 100 may include one or more market makers 130 which may maintain a market by providing constant bid and offer prices for a derivative or security to the exchange computer system 100, such as via one of the exemplary computer devices depicted. The exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on a non-transitory computer-readable medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may include other components not shown and be connected by numerous alternative topologies.

In one embodiment, the market data module 112 is further operative to generate price quotations for products, such as spreads, as will be described below. It will be appreciated that the functionality implemented by the market data module 112 described below may alternatively be implemented by a separate module, such as a quote processor (not shown) or may be incorporated in one or more of the other components of the exchange computer system 100 described above.

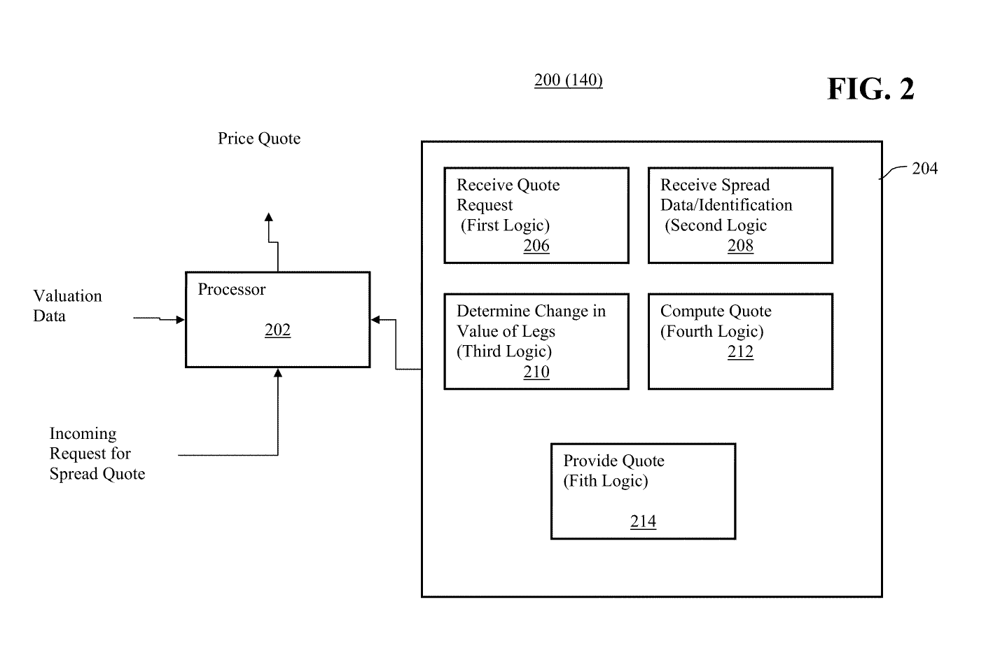

FIG. 2 depicts a block diagram of the market data module 112 according to one embodiment, which in an exemplary implementation, is implemented as part of the exchange computer system 100 described above. As used herein, an exchange 100 includes a place or system that receives and/or executes orders.

In particular, FIG. 2 shows a system 200 for determining a quotation price of a spread product comprising at least two component products having non-homogeneous construction. In one embodiment, the first component product may be a US Treasury Futures contract and the second component product may be a Eurodollar Futures Pack, the Eurodollar Futures Pack comprising a plurality of Eurodollar Futures contracts. As discussed above, the disclosed embodiments may be utilized in conjunction with spreads between, for example, a first component product which may be characterized by being quoted in price terms and a second component product which characterized by being quoted in rate, or implied rate, terms, such as a first component product which is a currency futures contract and the second component product which is a short-term interest rate futures contract. The disclosed embodiments may be further applicable to generating price quotations for spreads between products having divergent constructions such as where the first component product comprises a crude oil futures contract and the second component product comprises a natural gas futures contract.

The system 200 includes a processor 202 and a memory 204 coupled therewith which may be implemented as a processor 402 and memory 404 as described below with respect to FIG. 4. The system 200 further includes first logic 206 stored in the memory 204 and executable by the processor 202 to cause the processor 202 to receive a request for the quotation price of the spread product.

The system 200 further includes second logic 208 stored in the memory 204 and executable by the processor 202 to cause the processor 202 to receive identification of the contract spread, the identification further identifying a quantity ratio of a first quantity of a first component product of the at least two component products to a second quantity of a second component product of the at least two component products, the first component product being characterized by a first minimum price increment and the second component product being characterized by a second minimum price increment.

In one embodiment, the second minimum price increment is defined for the Eurodollar Futures Pack as a minimum price increment of a Eurodollars Futures contract of the Eurodollar Futures Pack multiplied by the number of Eurodollars Futures contracts in the Eurodollar Futures Pack

In one embodiment, the second logic is further executable by the processor to cause the processor to determine the first and second quantities such that a risk exposure of the first quantity of the first component product substantially matches a risk exposure of the second quantity of the second component product.

The system 200 further includes third logic 210 stored in the memory 204 and executable by the processor 202 to cause the processor 202 to determine a change in value of each of the first and second component products.

In one embodiment, the change is value of each of the first and second component products is determined based on a closing price thereof at the end of a prior trading session.

The system 200 further includes fourth logic 212 stored in the memory 204 and executable by the processor 202 to cause the processor 202 to compute the quotation price based on the difference between the change in value of the first component product and the change in value of the second component product adjusted based on a ratio of the first minimum price increment to the second minimum price increment multiplied by the quantity ratio of the spread

The system 200 further includes fifth logic 214 stored in the memory 204 and executable by the processor 202 to cause the processor 202 to provide the computed quotation price responsive to the received request.

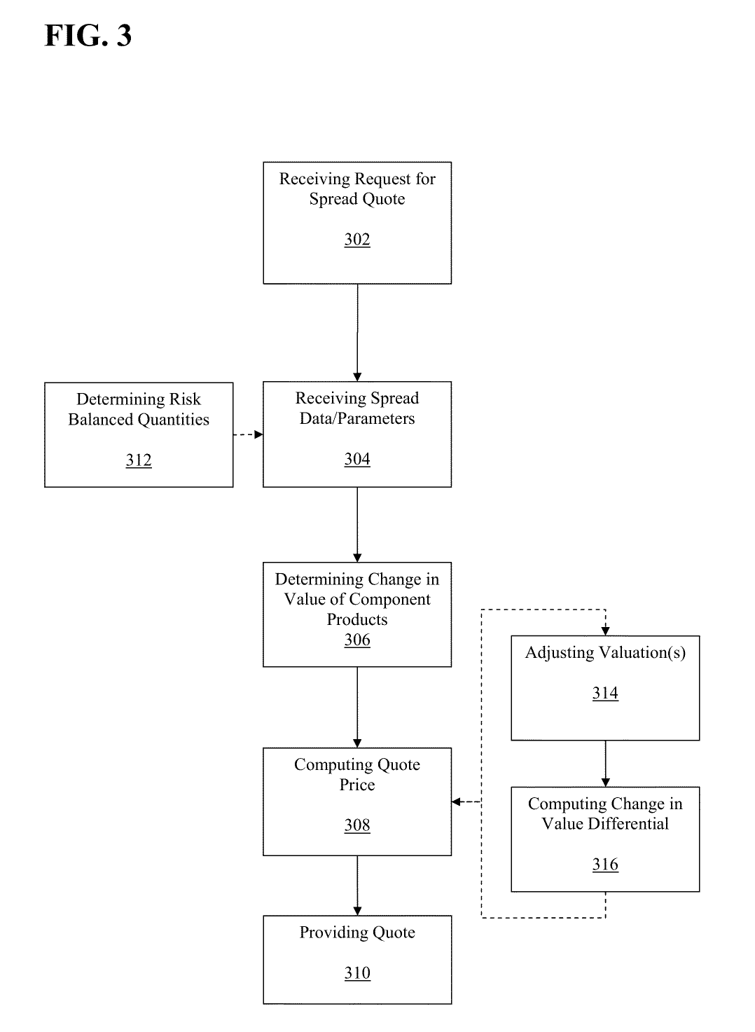

FIG. 3 depicts a flow chart showing operation of the system 200 of FIG. 2. In particular FIG. 3 shows a computer implemented method for determining a quotation price of a spread product comprising at least two component products having non-homogeneous construction, such as wherein the first component product comprises a US Treasury Futures contract and the second component product comprises a Eurodollar Futures Pack, the Eurodollar Futures Pack comprising a plurality of Eurodollar Futures contracts or other spread between products of divergent construction such as wherein the first component product is characterized by being quoted in price terms and the second component product is characterized by being quoted in rate, or implied rate, terms, e.g. currency futures contracts vs short-term interest rate futures contracts or crude oil futures vs natural gas futures.

The operation of the system 200 further includes receiving, by a processor 202, a request for the quotation price of the spread product [block 302] and receiving, by the processor 202, identification of the contract spread, the identification further identifying a quantity ratio of a first quantity of a first component product of the at least two component products to a second quantity of a second component product of the at least two component products, the first component product being characterized by a first minimum price increment and the second component product being characterized by a second minimum price increment [block 304].

In one embodiment, the operation of the system 200 may further include determining, by the processor 202, the first and second quantities such that a risk exposure of the first quantity of the first component product substantially matches a risk exposure of the second quantity of the second component product [block 312].

The operation of the system 200 further includes determining, by the processor 202, a change in value of each of the first and second component products, such as wherein the change is value of each of the first and second component products is determined based on a closing price thereof at the end of a prior trading session [block 306]. For spreads between US Treasury Futures contracts and Eurodollar futures contract packs, the second minimum price increment may be defined for the Eurodollar Futures Pack as a minimum price increment of a Eurodollars Futures contract of the Eurodollar Futures Pack multiplied by the number of Eurodollars Futures contracts in the Eurodollar Futures Pack

The operation of the system 200 further includes computing, by the processor 202, the quotation price based on the difference between the change in value of the first component product and the change in value of the second component product adjusted based on a ratio of the first minimum price increment to the second minimum price increment multiplied by the quantity ratio of the spread [block 308]. In one embodiment, the computation of the quotation price may further include adjusting, by the processor, the change in value of the second leg product based on the quantity ratio leveled to account for a difference between a minimum price increment of the first leg product and a minimum price difference for the second leg product [block 314] and computing, by the processor 202, the quotation price as the difference between the change in value of the first leg product and the adjusted change in value of the second leg product [block 316].

The operation of the system 200 further includes providing, by the processor 202, the computed quotation price responsive to the received request.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above, such as the processor 202, may be a computer system 400 or a component in the computer system 400. The computer system 400 may implement a match engine, margin processing, payment or clearing function on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

The present status of the claims is as follows:

1. A computer implemented method for determining a quotation price of a spread product comprising at least two component products having non-homogeneous construction, the method comprising:
receiving, by a processor, a request for the quotation price of the spread product;
receiving, by the processor, identification of the contract spread, the identification further identifying a quantity ratio of a first quantity of a first component product of the at least two component products to a second quantity of a second component product of the at least two component products, the first component product being characterized by a first minimum price increment and the second component product being characterized by a second minimum price increment;
determining, by the processor, a change in value of each of the first and second component products;
computing, by the processor, the quotation price based on the difference between the change in value of the first component product and the change in value of the second component product adjusted based on a ratio of the first minimum price increment to the second minimum price increment multiplied by the quantity ratio of the spread; and
providing, by the processor, the computed quotation price responsive to the received request.

2. The computer implemented method of claim 1 further comprising determining the first and second quantities such that a risk exposure of the first quantity of the first component product substantially matches a risk exposure of the second quantity of the second component product.

3. The computer implemented method of claim 1 wherein the first component product comprises a US Treasury Futures contract and the second component product comprises a Eurodollar Futures Pack, the Eurodollar Futures Pack comprising a plurality of Eurodollar Futures contracts.

4. The computer implemented method of claim 3 wherein the second minimum price increment is defined for the Eurodollar Futures Pack as a minimum price increment of a Eurodollars Futures contract of the Eurodollar Futures Pack multiplied by the number of Eurodollars Futures contracts in the Eurodollar Futures Pack.

5. The computer implemented method of claim 1 wherein the first component product is characterized by being quoted in price terms and the second component product is characterized by being quoted in rate terms.

6. The computer implemented method of claim 1 wherein the first component product comprises a currency futures contract and the second component product comprises a short-term interest rate futures contract.

7. The computer implemented method of claim 1 wherein the first component product comprises a crude oil futures contract and the second component product comprises a natural gas futures contract.

8. The computer implemented method of claim 1 wherein the change is value of each of the first and second component products is determined based on a closing price thereof at the end of a prior trading session

9. A system for determining a quotation price of a spread product comprising at least two component products having non-homogeneous construction, the system comprising a processor and a memory coupled therewith, the system further comprising:
first logic stored in the memory and executable by the processor to cause the processor to receive a request for the quotation price of the spread product;
second logic stored in the memory and executable by the processor to cause the processor to receive identification of the contract spread, the identification further identifying a quantity ratio of a first quantity of a first component product of the at least two component products to a second quantity of a second component product of the at least two component products, the first component product being characterized by a first minimum price increment and the second component product being characterized by a second minimum price increment;
third logic stored in the memory and executable by the processor to cause the processor to determine a change in value of each of the first and second component products;
fourth logic stored in the memory and executable by the processor to cause the processor to compute the quotation price based on the difference between the change in value of the first component product and the change in value of the second component product adjusted based on a ratio of the first minimum price increment to the second minimum price increment multiplied by the quantity ratio of the spread; and
fifth logic stored in the memory and executable by the processor to cause the processor to provide the computed quotation price responsive to the received request.

10. The system of claim 9 wherein the second logic is further executable by the processor to cause the processor to determine the first and second quantities such that a risk exposure of the first quantity of the first component product substantially matches a risk exposure of the second quantity of the second component product.

11. The system of claim 9 wherein the first component product comprises a US Treasury Futures contract and the second component product comprises a Eurodollar Futures Pack, the Eurodollar Futures Pack comprising a plurality of Eurodollar Futures contracts.

12. The system of claim 11 wherein the second minimum price increment is defined for the Eurodollar Futures Pack as a minimum price increment of a Eurodollars Futures contract of the Eurodollar Futures Pack multiplied by the number of Eurodollars Futures contracts in the Eurodollar Futures Pack.

13. The system of claim 9 wherein the first component product is characterized by being quoted in price terms and the second component product is characterized by being quoted in rate terms.

14. The system of claim 9 wherein the first component product comprises a currency futures contract and the second component product comprises a short-term interest rate futures contract.

15. The system of claim 9 wherein the first component product comprises a crude oil futures contract and the second component product comprises a natural gas futures contract.

16. The system of claim 9 wherein the change is value of each of the first and second component products is determined based on a closing price thereof at the end of a prior trading session.

17. A computer implemented method for determining a quotation price of a spread between a first leg product quoted in terms of a price and a second leg quoted in terms of a rate, the method comprising:
determining, by a processor, a first quantity of the first leg product having an equivalent risk of loss to a second quantity of the second leg product and computing a quantity ratio of the first quantity to the second quantity;
determining, by the processor, a change in value of each of the first and second leg products for a period of time;
adjusting, by the processor, the change in value of the second leg product based on the quantity ratio leveled to account for a difference between a minimum price increment of the first leg product and a minimum price difference for the second leg product; and
computing, by the processor, the quotation price as the difference between the change in value of the first leg product and the adjusted change in value of the second leg product.

18. The computer implemented method of claim 17 wherein the first leg product comprises a US Treasury Futures contract and the second leg product comprises a Eurodollar Futures Pack, the Eurodollar Futures Pack comprising a plurality of Eurodollar Futures contracts.

19. The computer implemented method of claim 17 wherein the change is value of each of the first and second leg products is determined based on a closing price thereof at the end of a prior trading session.

20. The computer implemented method of claim 17 wherein the first component product comprises a currency futures contract and the second component product comprises a short-term interest rate futures contract.
